(19) United States
(12) Patent Application Publication
(10) Pub. No.: US 2001/0042346 A1
(43) Pub. Date: Nov. 22, 2001

(54) Horizontally unfurled spring assisted furling screen for walkways

(76) Inventor: Roberto Brioschi, Bogogno (IT)

Correspondence Address: Burton A. Amernick, Connolly Bove Lodge & Hutz LLP, Suite 800, 1990 M Street, N.W., Washington, DC, 20036-3425, US

(21) Appl. No.: 09/854,521

(22) Filed: May 15, 2001

(30) Foreign Application Priority Data
May 15, 2000 (EP) 00830351.3

(51) Int. Cl. E05F 1/00

(52) U.S. Cl. 49/447; 49/445

(57) ABSTRACT

A horizontally sliding screen for door or French window apertures comprising a first module (1) containing a spring assisted roll-back mechanism (3, 4) fastened to a post of the aperture, a second abutment module (16) for a stiffening end bar (8) of the screen (7), fastened to the opposite post, upper (11) and lower (10) channel guides for the said end bar (8) and optionally for the edges of the extended screen (7), respectively fastened to the threshold and the upper crossbar of the aperture, further comprises a rope (21) whose ends are respectively fastened to said end bar (8) running inside and run inside the said channel guides (10, 11), and on pulleys (18, 19, 20) fitted inside said second abutment module (16); a sagging (A) of the said rope (21) loaded with a weight (P) suspended by means of a hook (22) between two of said pulleys lower than or equal to the force exerted by the spring (4) of said roll-back mechanism increased by an amount equal to the sum of the frictional forces acting on the sliding parts.

### FIELD OF THE INVENTION

This invention relates in general to spring assisted roll-back screens for door, window or French-window apertures.

### BACKGROUND OF THE INVENTION

Spring assisted roll-back screens, meaning with this term mosquito nets, “see-through” curtains to limit glare and direct light, for apertures as windows, doors and French windows of homes, offices, guardrooms, cabins and the like, are familiar devices of everyday use and their construction is well known.

Basically, they consist of a channel-shaped or box-shaped module containing a spring roller on which the screen, mosquito net, curtain or the like, is eventually rolled back which can be one side of the aperture.

A second abutment and retention module is usually provided on the opposite side of the aperture.

The free end of the curtain, screen or mosquito net is normally fixed to a stiff end bar fitted with looking devices, cooperating with locking features provided in the abutment module such to hold the end bar, of the fully extended screen, opposing the pull back force of the spring-roller, typically provided by a torsional helical spring.

Usually, and of course as a rule with mosquito nets in order to ensure “tightness” along the perimeter of the screened aperture, special guides, respectively fastened on the other two opposite sides of the aperture are provided, into which the opposite ends of the end bar and the edges of the screen sealingly slide.

While, in the case of windows, it is rather common to install the device so that the screen or curtain or mosquito net may be pulled down vertically and roll-back in the module containing the wind-back roller, which in this case is installed on the horizontal upper side of the window's aperture, in other situations and specially in the case of doors and French windows, a horizontally extended and roll-back screen is ergonomically much more convenient.

With doors and French windows of relatively large apertures and/or relatively high, the installation of a horizontally slidable roll-back screen or mosquito net is imperative.

The relatively large size, the augmented relevance of friction, often increased by the presence of perimetral sealing brushes for preventing insects from entering the room, imposes the use of return springs capable of providing a pull-back force sufficient to promote an effective and proper screen wind-back upon unlocking the end bar (by acting manually on a handle or the like) from its retention seat, for example to walk though the door.

With the known devices, when the end bar of the screen is released from the fully extended and locked position, it is necessary to control its movement by holding on the handle and exert a certain force to partially resist the roll-back force of the return spring. This in order to promote an even wind-back of the screen or mosquito net on the roller and prevent the formation of creases. Frequent and unavoidable accidental losses of the grip on the maneuvering handle cause the screen to wind back on the roller abruptly, causing the end bar to slam against either the rolled screen or the lips of a slot, through which the screen passes, of the box-shaped module accommodating the roller and the spring-operated wind-back mechanism.

### SUMMARY OF THE INVENTION

These drawbacks are eliminated or rendered negligible by the simple as effective device of the present invention.

A particularly remarkable aspect of the solution found is the fact that the invention can be implemented at a very low cost even on existing screens or mosquito nets by merely replacing the abutment module and fastening the ends of a fine rope to the bottom and top ends, respectively, of the end bar that normally slide into the bottom lower and top guides.

Essentially, the fine rope whose ends are so fastened respectively to the lower and upper ends of the end bar and which run unobtrusively inside the end-bar guides runs over pulleys mounted inside the abutment module in a way such to form a vertically extending and shrinking sag in the trough of which is suspended a free pulley loaded with a weight.

The weight the rope maintains on the two legs respectively fastened to the ends of the end bar a tension which is lower than or equal to the sum of the frictional forces acting on the roll-back and slide organs and of the pulling force produced by the spring of the wind-back roller.

In practice, the freely suspended weight of the rope system housed in a compartment of the abutment module, provides through its two legs fastened to the end bar of the roll-back screen, a substantially balancing force, comparable to, or preferably slightly lower than the pulling force produced by the spring assisted roll-back mechanism.

In this way, upon unlocking the fully extended screen to retract it, the screen is no longer subject to an excessive pulling force from the wind-back spring mechanism, and its rolling back can be easily controlled by ensuring at all times a force equal to or slightly lower than the force of the wind-back spring (minus frictional forces).

These conditions always ensure a proper and uniform winding and, optionally, by adequately adjusting the suspended weight opposing the wind-back spring force, a substantial balance of forces can be achieved so that the winding occurs by shifting manually the end bar toward the wind-back roller.

In practice, according to the latter type of embodiment, the screen can stably remain in any position of partial extension across the aperture without the need of any locking device to hold it in a certain position.

### BRIEF DESCRIPTION OF THE DRAWING

FIG. 1 is an exploded view of a horizontally-slided spring assisted roll-back screen equipped with the device of the invention.

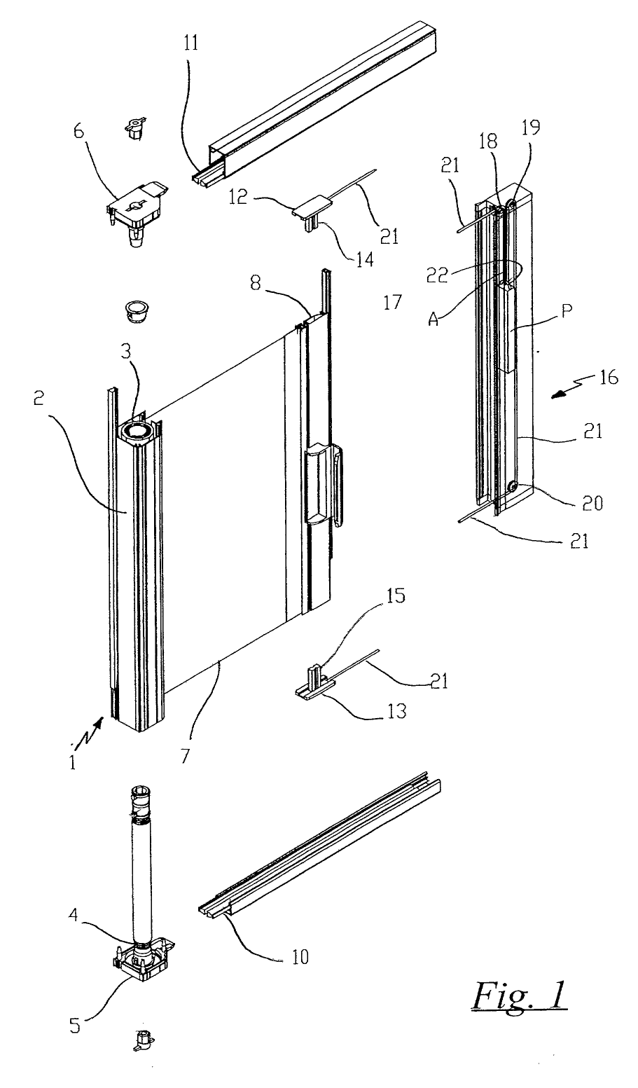

FIG. 2 shows an assembled screen.

FIG. 3 is a detailed view of the device of the invention.

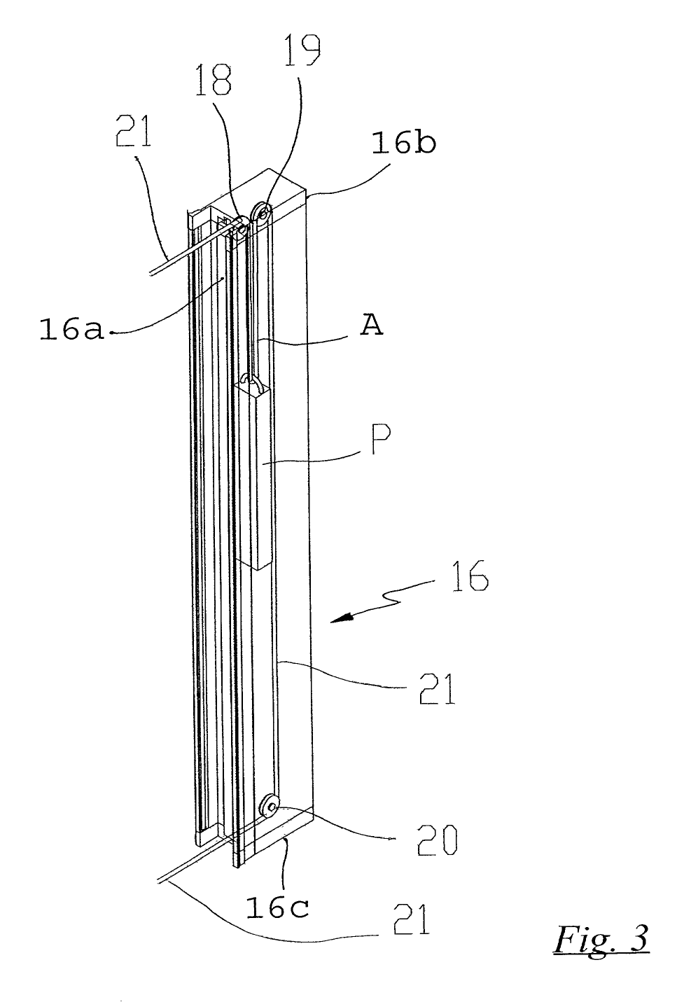

### DESCRIPTION OF AN EMBODIMENT OF THE INVENTION

With reference to the figures, where the same parts are identified with the same numbers, the roll-back module 1 consists of a channel-shaped or box-shaped casing 2, designed to accommodate a winding roller 3 a torsional elicoidal return spring mechanism 4, rotatably held on opposite end caps 5 and 6 of the channel-shaped casing 2.

The hardware of installation of the roller 3 and of the return-spring mechanism 4 between the caps 5 and 6, as well as that for fastening the module to a lateral post of the aperture are of usual workmanship and their detailed description is not deemed necessary to fully understand the subject matter of this invention.

The roll-back screen 7 may be a fine net, e.g. a mosquito net, an obscuring fabric, a “see-through” mesh-like fabric or any other technical material, according to need.

The free end of the roll-back screen is stiffened by an end bar 8, customarily provided with handles 9 to maneuver the extendable roll-back screen.

In the example shown, the end bar 8 is in the form of a narrow U-shaped channel closed by a profile 17 that abuts against a rubber gasket profile 16a of the abutment module 16. Snap-shut locking devices, or more preferably simple magnets, may be optionally provided to retain the fully extended screen. The handle 9 is used to guide the screen. If mechanical locking devices are present, the handle can also have the function of releasing them when the screen has to be rolled back to clear the passage.

The bottom and top ends of the stiffening bar 8 engage into the respective channel-like guides 10 and 11 functionally fastened along the bottom side (threshold) and the top side of the aperture.

In the example shown, the engagement is established by two respective sledges 12 and 13, whose coupling shanks, respectively 14 and 15, fit into the ends of the channel-shaped bar 8.

In the case of a mosquito net, the upper and lower edges of the screen 7, typically consisting of a fine mesh of synthetic or coated glass fibers or alike materials, slide inside the two channel guides 10 and 11 to provide for a perimetral “tightness” in preventing or hinder the entering of insects.

As schematically shown in the figure, a space defined at the back of the gasket-profile 16a, optionally by a septum 16b of the channel-shaped casing 16, accommodates pulleys 18, 19 and 20 on which the fine rope 21 runs, whose ends are fastened to the sledges 12 and 13 fitted the two ends of the bar 8.

The pulleys inside the channel-shaped casing 16 of the abutment module 16 lead the rope to form a sagging A that extends down shrinks up coordinately with the horizontal sliding of the screen, being loaded with a weight P suspended by means of a hook or a pulley 22.

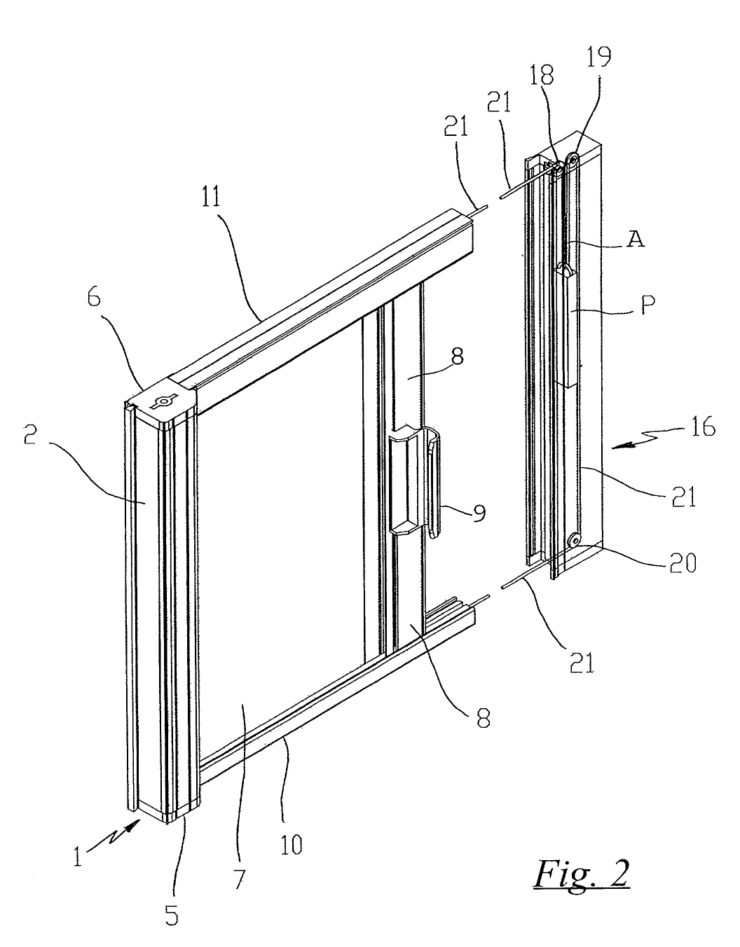

Matching caps 16c and 16d (FIG. 2) close the space that houses the device.

All the compartment parts of the roll-back spring force counterbalancing device of the invention, including the two rope legs 21, remain out of sight because the two legs of the rope run inside the guides 10 and 11 and the multi-pulley system is housed in a compartment defined in the abutment module 16.

It is evident that, in case of preexisting roll-back screens, the existing abutment module 16 can be easily replaced with a similar element perfectly matching with the other components of the spring assisted roll-back screen, but shaped in such a way as to contain the pulley and counterbalancing weight system of the invention in a purposely defined inner space.

Once the abutment module has been replaced, it is sufficient to fasten the ends of the rope 21 to the sledges 12d 13 of the stiffening bar 8 to complete the “retrofitting”.

The stroke of the roll-back screen and the width of the door opening may ultimately decrease by 15 to 25 mm, corresponding to the depth of the compartment accommodating the pulley and counterbalancing weight system. Such a restriction of the free aperture is in most cases negligible.

1. A horizontally sliding screen for door or French window apertures comprising a first module (1) containing a spring assisted roll-back mechanism (3, 4) fastened to a post of the aperture, a second abutment module (16) for a stiffening end bar (8) of the screen (7), fastened to the opposite post, upper (11) and lower (10) channel guides for the said end bar (8) and optionally for the edges of the extended screen (7), respectively fastened to the threshold and the upper crossbar of the aperture, characterized in that it comprises:
a rope (21) whose ends are respectively fastened to said end bar (8) running inside and run inside the said channel guides (10, 11), and on pulleys (18, 19, 20) fitted inside said second abutment module (16);
a sagging (A) of the said rope (21) loaded with a weight (P) suspended by means of a hook (22) between two of said pulleys lower than or equal to the force exerted by the spring (4) of said roll-back mechanism increased by an amount equal to the sum of the frictional forces acting on the sliding parts.

2. A horizontally sliding screen according to claim 1, characterized in that said end bar (8) and said second abutment module (16) have cooperating parts to lock and release the screen fully extended across the aperture and a handle (9).
